(19) United States
(12) Patent Application Publication
(10) Pub. No.: US 2026/0368100 A1
(43) Pub. Date: Nov. 19, 2026

(54) Contiguous Queues with Address Translation Service (ATS)

(71) Applicant: Sandisk Technologies, Inc., Milpitas, CA (US)

(72) Inventors: Amir SEGEV, Meiter (IL); Shay BENISTY, Beer Sheva (IL); Amir ROZEN, Rishon Lezion (IL)

(73) Assignee: Sandisk Technologies, Inc., Milpitas, CA (US)

(21) Appl. No.: 19/206,212

(22) Filed: May 13, 2025

(51) Int. Cl. G06F 12/10; G06F 12/0802

(52) U.S. Cl. CPC G06F 12/10; G06F 12/0802; G06F 2212/45

(57) ABSTRACT

Address translation service (ATS) involves fetching the actual addresses for commands from a host device for virtual addresses that are provided with a command in a submission queue (SQ). The fetched translated addresses are stored in an address translation cache (ATC) in a data storage device. With increasing SQ size comes an increase in translated addresses in the ATC, which leads to needing more cache. To save cache, it is beneficial to obtain translated addresses one or two at a time rather than in a large batch. The translated addresses can be fetched while processing the command just previous thereto. The translated address would then be ready for use when the command is ready to be fetched. The process repeats by fetching translated addresses as the previous command is in process so that the translated address arrives just in time for use. In so doing, less cache is needed.

### BACKGROUND OF THE DISCLOSURE

### Field of the Disclosure

Embodiments of the present disclosure generally relate to improving address translation service (ATS) usage in a data storage device.

### Description of the Related Art

Address translation service (ATS) is a feature where a host device does not provide the physical addresses, but instead provides virtual addresses, and before using those virtual addresses, a translation is needed. In order to translate those virtual addresses, the device controller of the data storage device interacts with a translation agent (TA). The device controller provides the untranslated address to the TA and asks for translation service. The response will be a translated address associated with the specific untranslated address.

In order to minimize the overhead in the system and the many packets that need to transfer over an interface between the host device and the data storage device, the device controller may implement an address translation cache (ATC). The ATC is useful because in the future, there might be the same untranslated address that needs translating and instead of sending immediately to the TA in order to get the translated address, the ATC is checked to see whether the translation is present. If the translation is present, the extra overhead on the interface is avoided. When the ATC is used, all the addresses in the system, including the submission queues (SQs), completion queues (CQs), pointers, PRPs, SGLs, etc. will use the ATC.

The data storage device obtains a pointer to a SQ. The data storage device then holds translated addresses of the SQ in ATC, which, for a single SQ, involves a lot of entries. The more SQs that are present, the more expensive cache is required.

Therefore, there is a need in the art for improved ATS usage.

### SUMMARY OF THE DISCLOSURE

Address translation service (ATS) involves fetching the actual addresses for commands from a host device for virtual addresses that are provided with a command in a submission queue (SQ). The fetched translated addresses are stored in an address translation cache (ATC) in a data storage device. With increasing SQ size comes an increase in translated addresses in the ATC, which leads to needing more cache. To save cache, it is beneficial to obtain translated addresses one or two at a time rather than in a large batch. The translated addresses can be fetched while processing the command just previous thereto. The translated address would then be ready for use when the command is ready to be fetched. The process repeats by fetching translated addresses as the previous command is in process so that the translated address arrives just in time for use. In so doing, less cache is needed.

In one embodiment, a data storage device comprises: a memory device; and a controller coupled to the memory device, wherein the controller is configured to: read a first command from a SQ using a translated address; prepare a next fetch address; execute the first command; and send a completion notification.

In another embodiment, a data storage device comprises: a memory device; and a controller coupled to the memory device, wherein the controller is configured to: receive a doorbell; perform an address translation on a SQ; fetch a first command from the SQ; execute the first command; and translate a SQ location for a second command, wherein the translating the SQ location for the second command occurs in parallel with executing the first command.

In another embodiment, a data storage device comprises: means to store data; and a controller coupled to the means to store data, wherein the controller is configured to: store a single untranslated base address per submission queue (SQ) in cache; and issue address translation requests on the fly, wherein the requests are issued before crossing address translation boundaries.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2A is a schematic illustration of the empty queue definition as provided by the nonvolatile memory (NVM) express (NVMe) base specification.

FIG. 2B is a schematic illustration of the full queue definition as provided by the NVMe base specification.

FIG. 3 is a schematic illustration of a buffer shared by multiple functions according to one embodiment.

FIG. 4 is a schematic diagram illustrating a multi-tenancy system supporting address translation service (ATS) functionality, according to certain embodiments.

FIG. 5A is a flowchart illustrating address translation flow according to one embodiment.

FIG. 5B is a flowchart illustrating preparing the next fetch address according to one embodiment.

FIG. 6A is a flowchart illustrating submission queue creation according to one embodiment.

FIG. 6B is a flowchart illustrating preparation of the next fetch address according to one embodiment.

FIG. 7 is a flowchart illustrating ATS processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Address translation service (ATS) involves fetching the actual addresses for commands from a host device for virtual addresses that are provided with a command in a submission queue (SQ). The fetched translated addresses are stored in an address translation cache (ATC) in a data storage device. With increasing SQ size comes an increase in translated addresses in the ATC, which leads to needing more cache. To save cache, it is beneficial to obtain translated addresses one or two at a time rather than in a large batch. The translated addresses can be fetched while processing the command just previous thereto. The translated address would then be ready for use when the command is ready to be fetched. The process repeats by fetching translated addresses as the previous command is in process so that the translated address arrives just in time for use. In so doing, less cache is needed.

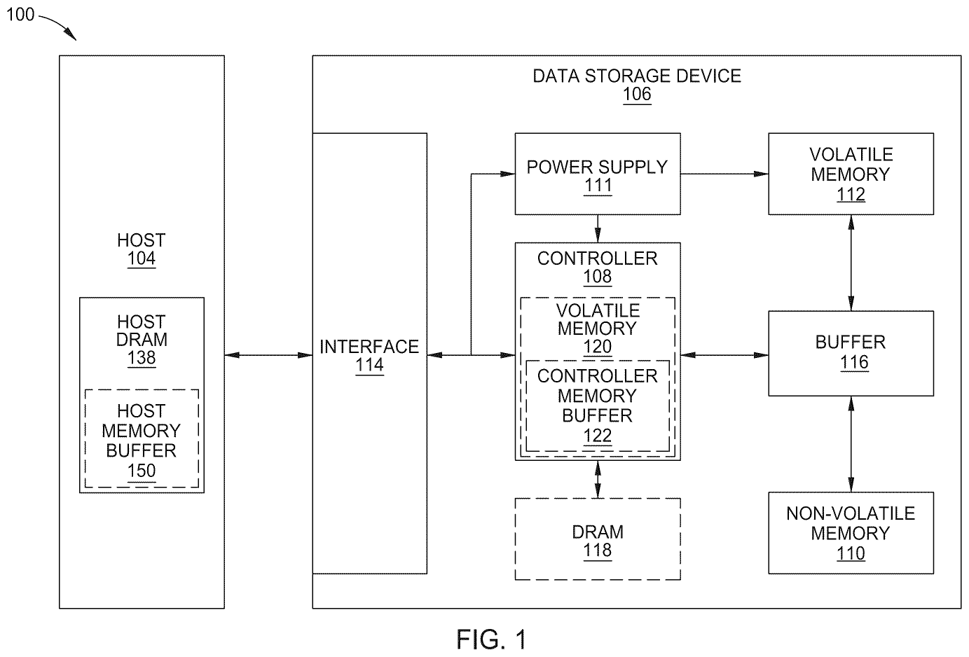

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4,x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

ATS typically means that the address obtained from the command, or even the addresses fetched from a physical region page (PRP) list from a host device DRAM is not the actual addresses of the DRAM. The addresses are virtual addresses and the ATS provides a mechanism to ask the host device what the real address of the DRAM is for access purposes. The data storage device asks the host device for the translation. If using transaction layer packets (TLPs), as an example, assume each packet is 512 bytes and has a different 4K address (i.e., the minimum granularity of the address translation). If the data storage device needs to access a 4K using a 512 byte TLP size, then the data storage device will need to access the host device eight times, and the host device will need to do a translation eight times. The translation will need to occur for each TLP translation. If the data storage device is asking the host device to tell the data storage device where those real 4K are located, the data storage device can ask the host device once and then the data storage device can send all eight TLPs to the actual address.

Considering continuous queues before address translation, there was the base for the queue and for every time the data storage device wanted to read a command, the data storage device would increase the read pointer by 64. The first command would be the base address of the queue, the second command would be the base address plus 64, and so on. But now, when the host device tells the data storage device that there is a continuous queue with address translation for each 4K of the queue, the queue is not really contiguous on the host device side, the data storage device needs to translate every 4K separately. Thus, a big cache is needed to support a high queue number. Therefore, for a queue depth of 64K, the cache is not cheap. If the data storage device needs to hold 4K of the SQ of each SQ in a system, and each SQ can be 64K entries, there might be 2K SQs that comes to 2 megabytes of pointers to 4K, which is very memory intensive and expensive.

The idea is to translate in advance the next 4K that the data storage device controller needs to hold. Obviously, the controller needs the first 4K to be translated, but the controller is always looking and fetching the next command at the same time as executing the current command. When the SQ is finished, the controller goes to the beginning of the SQ again (i.e., wraps around) and translates the first command in the SQ again. Thus, the data storage device has an extra request for translation (i.e., the first command in the SQ is translated twice in a wrap scenario), but the ratio of re-fetching is low, such as once in sixty four commands, and thus the cost in bandwidth is very low. So at a high level, the idea is to ask for address translation after fetching the last command out of the previously translated address. The controller will not wait until needing to fetch the next command and thus will not cause any back pressure. To fetch the next command, the controller will not wait. As soon as the controller is done with the 4K, the controller will ask for the translation of the next 4K. It is to be noted that sometimes it is more than 4K, but worst case is each translation is 4K.

In considering an NVMe SQ, a SQ can describe up to 64K commands where each command is 64 bytes long. Thus, a single SQ might require 4 MB of memory. Each completion queue (CQ) entry is 16 bytes long, so 1 MB of memory might be required for CQs. The NVMe specification supports both contiguous queues, and non-contiguous queues. When dealing with a contiguous queue, a single pointer to the entire 4M for SQ (or 1M for CQ) is required.

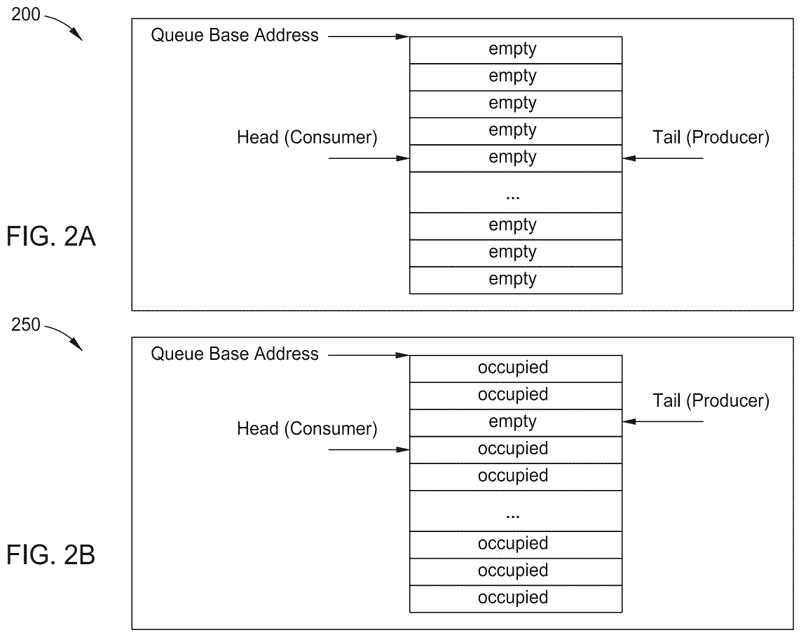

FIG. 2A is a schematic illustration 200 of the empty queue definition as provided by the NVMe base specification. The queue is empty when the head entry pointer equals the tail entry pointer. FIG. 2B is a schematic illustration 250 of the full queue definition as provided by the NVMe base specification. The queue is full when the head equals one more than the tail. The number of entries in a queue when full is one less than the queue size. It is to be noted that queue wrap conditions shall be taken into account when determining whether a queue is full.

The queues are cyclic. The host device first fills the command structure into “queue base address”+tail*64, and when the host device (i.e., producer in FIGS. 2A and 2B) writes a doorbell, the host device in fact increases the tail pointer managed by the data storage device. When the data storage device sees the tail has been increased, the data storage device knows there is a command to fetch and execute. Fetching the command is done by the data storage device reading 64 bytes from “queue base address”+tail*64. When the last 4 bytes of the SQ have been used, the tail pointer goes back to 0.

It is important to note that the instant disclosure does not discuss how the head of the SQ advances. How the head of the SQ advances is explained as part of the NVMe standard. Additionally, the same mechanism works for the CQ with the caveat that each entry in the CQ is 16 bytes, and the producer is actually the data storage device.

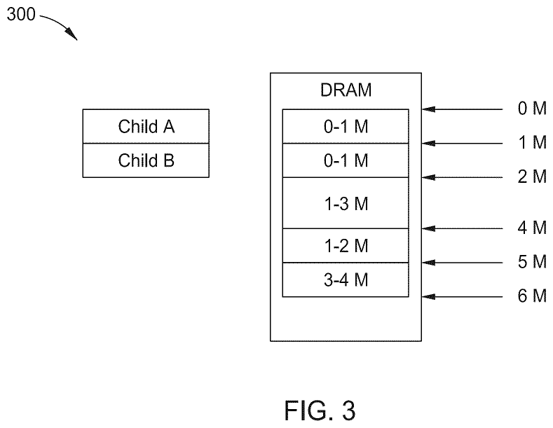

Considering now the ATS, when the host device and data storage device contain child functions, the child function believes the child function has one contiguous buffer, while the actual buffer range might not be contiguous. As such, when the child function attempts to access an address, the host device does the address translation and then the data storage device accesses the real range without knowing the child function address. An example is shown in FIG. 3, which is a schematic illustration 300 of a buffer shared by multiple functions according to one embodiment. In the example shown in FIG. 3, there is Child A having 4 MB total and Child B having 2 MB total. Each child believes the child has one big buffer, while the host device sees the buffer is fragmented. Child A's 4 MB is seen as 0-4 by Child A and as: 0-1, 2-4 and 5-6 by the host device. Similarly, Child B's 2 MB is see by Child B as 0-2 and as 1-2 and 4-5 by the host device.

From the data storage device point of view, the data storage device receives from the host device (i.e., from each child) a pointer to a SQ (and CQ). However, the data storage device is expected to use the real (translated) address when accessing the queues. For that reasoning, the data storage device is expected to ask for address translation (from the host device) before doing the actual transfer (read or write to the queues). The data storage device is also expected to hold an ATC so that the data storage device does not request an address translation for every access. The accesses are not limited to the queues, but also for the actual data.

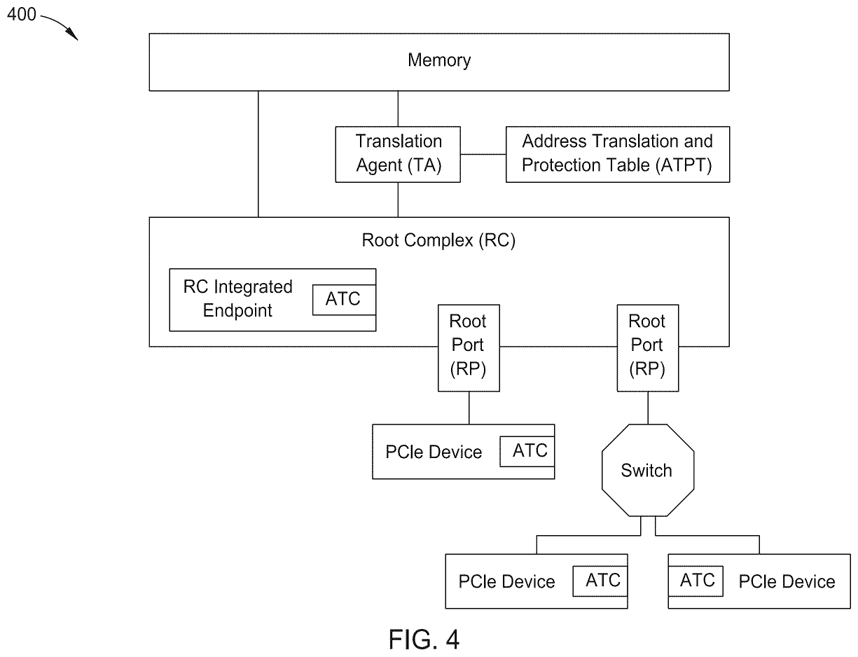

FIG. 4 is taken from the PCIe Standard. FIG. 4 is a schematic diagram illustrating a multi-tenancy system 400 supporting ATS functionality, according to certain embodiments. A translation agent (TA) services memory translation requests within the system. Within the TA, the ATC is referred to as a translation look-aside buffer (TLB) or address translation and protection table (ATPT). When the ATS enabled SSD device accesses system memory, the SSD shall cache translated addresses in an internal ATC. The ATC is different from the TLB translation cache used by the host device. When the ATS enabled SSD device shall implement and maintain a designated ATC to minimize performance dependencies on the TA and alleviate TA resource pressure.

Examples of PCIe addresses to be translated include: caching of SQ and CQ address ranges; SQ entry decoding including standard decoding of the data pointer for read or write that submit translation requests immediately, PRPs and SGLs that decode the data pointers and follow linked lists and upper bound of translations per large commands equal a rate match PRI translations with Gen5 bandwidth (BW) maximums, and DIX translation requests for metadata pointers and associated linked lists of addresses.

Most of the traffic between the host device and the data storage device is data. At the worst case, for each command (e.g., 64 bytes), 4K of data might pass. Thus, there is a 1:64 ratio. Holding a single SQ in the ATC will require 1K cache entries, as each entry might be of 4K bytes long, and the total size of a queue might be 4M bytes long. 4M/4K=1024. When working with 2048 SQs, this will involve around 2M entries. Each entry, only the host side address, is 8 bytes long (i.e., 64 bits address), which leads to 16M in cache for SQ, and 4 more for CQ. The instant disclosure resolves the need for the extra big cache size to support high-queue-number with high-queue-depth on system requiring ATS. While it is conceivable to hold all the translated address (e.g., 20 MB) in local DRAM, and fetch the translated addresses when required, such an approach has costs and does not work as well with DRAM-less products.

Storing only a single untranslated base address per SQ or CQ is proposed. The device controller would issue address-translated requests on-the-fly, just before crossing the address translation boundaries. The on-the-fly request incurs an overhead of only one extra address translation request per 64 commands in the worst case, which is deemed negligible. Moreover, the device controller would proactively issue address translation requests ahead-of-time, effectively concealing latency and preventing any performance degradation. The primary advantage of the approach is the reduction in area and cost of the storage device, resulting in a saving of approximately 0.5 MB of volatile memory (e.g., SRAM). Additionally, two possible embodiments are proposed: adjusting the ATS granularity to more than 4 KB, further reducing overhead and incorporating multiple cache entries for the next translated address per queue, potentially improving possible “bubbles” due to the latency. The embodiments can complement each other, with queues operating at 4K granularity utilizing multiple cache entries, while those operating at larger granularities employ a single cache entry.

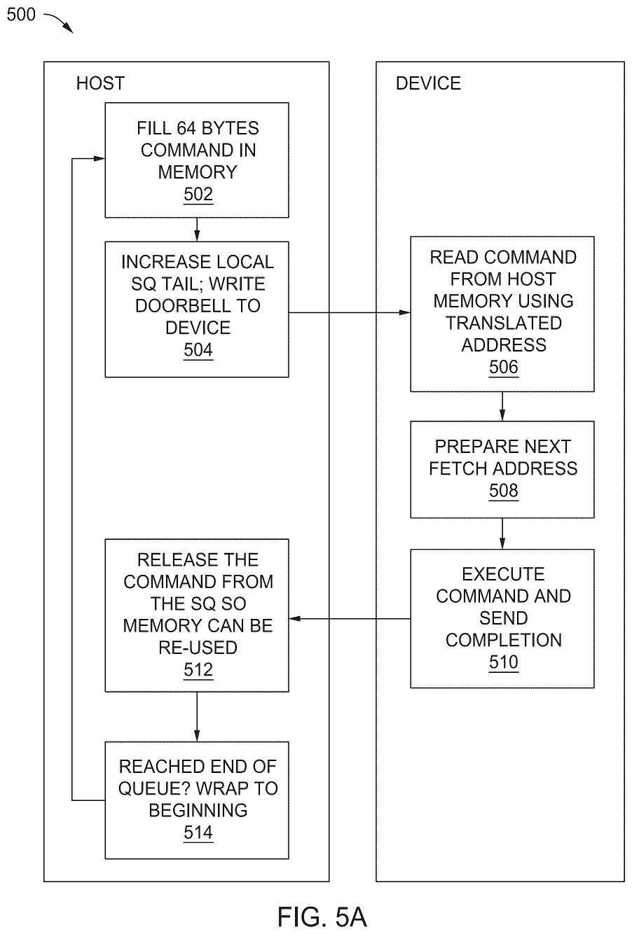

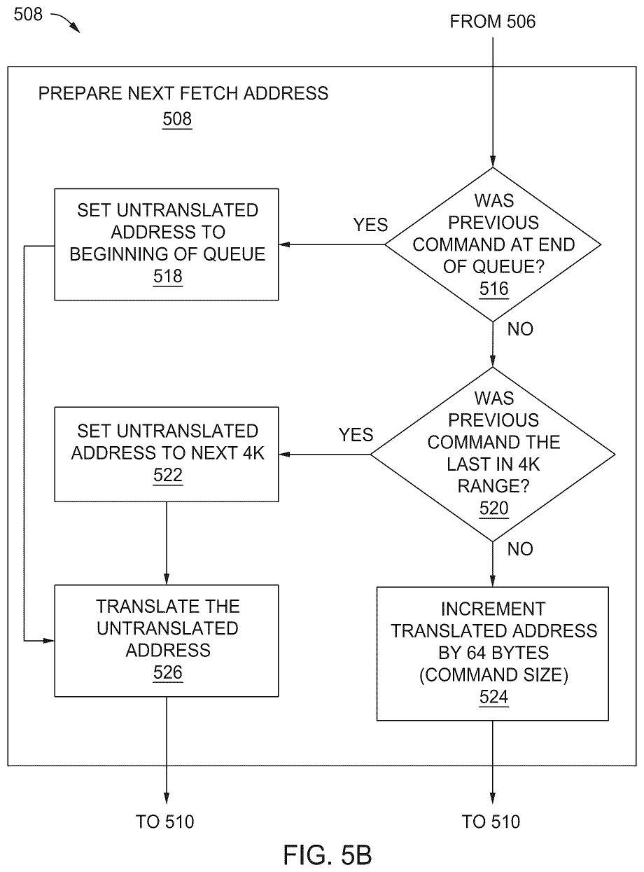

FIG. 5A is a flowchart 500 illustrating address translation flow according to one embodiment. FIG. 5B is a flowchart 550 illustrating preparing the next fetch address according to one embodiment. As shown in FIG. 5A, the host device fills a command in its own memory, 64 bytes in size, at block 502 and then increases the internal index so that the next command comes after the first and informs the device via a doorbell at block 504. The data storage device reads the command using the translated address which has been previously calculated at block 506 and prepares the next address to fetch command at block 508. The data storage device than goes to finish the command execution of the command and send a completion to the host device at block 510. The host device now marks the completed commands to track the head of the queue. The host device releases the command from the SQ so that the memory can be reused at block 512. If the host device has reached the end of queue, from a memory size perspective, the host device scrolls back to the beginning at block 514.

FIG. 5B is a “zoomed view” on how the data storage device prepares the next address. First, the data storage device checks if the previous fetch was from the end of the queue at block 516. If the fetch was taken from the end of the queue, then the data storage device takes the original untranslated base address of the queue at block 518 and translates the untranslated address at block 526. Second, the data storage device checks if the fetch was of the last command in the 4K (or smallest translation unit (STU)) which is the range that was translated previously at block 520. If the fetch indeed was the last command of the 4K, then the data storage device takes the next 4K (untranslated) range by setting the untranslated address to the next 4K at block 522 and translates the untranslated address at block 526. Otherwise, the data storage device just increments the fetch pointer by 64, which is the translated address pointer, at block 524.

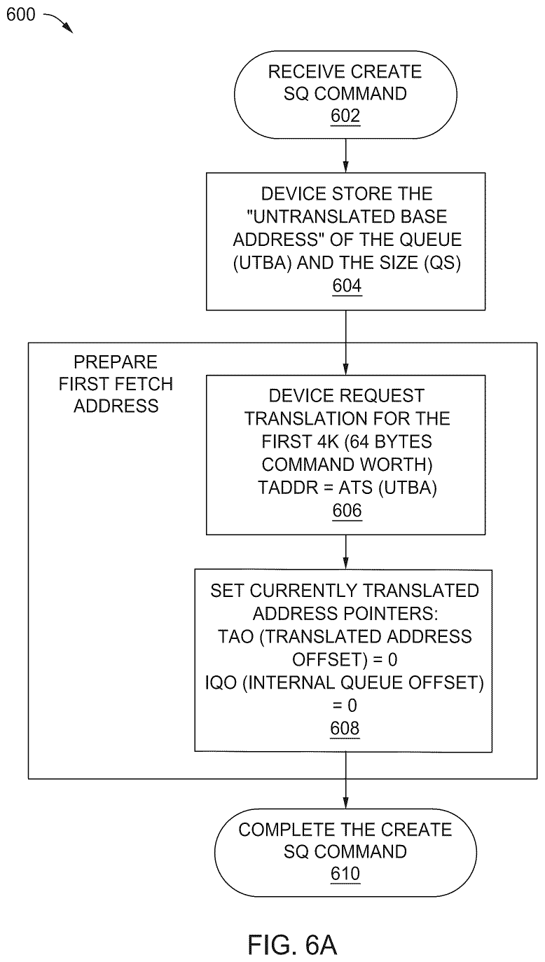

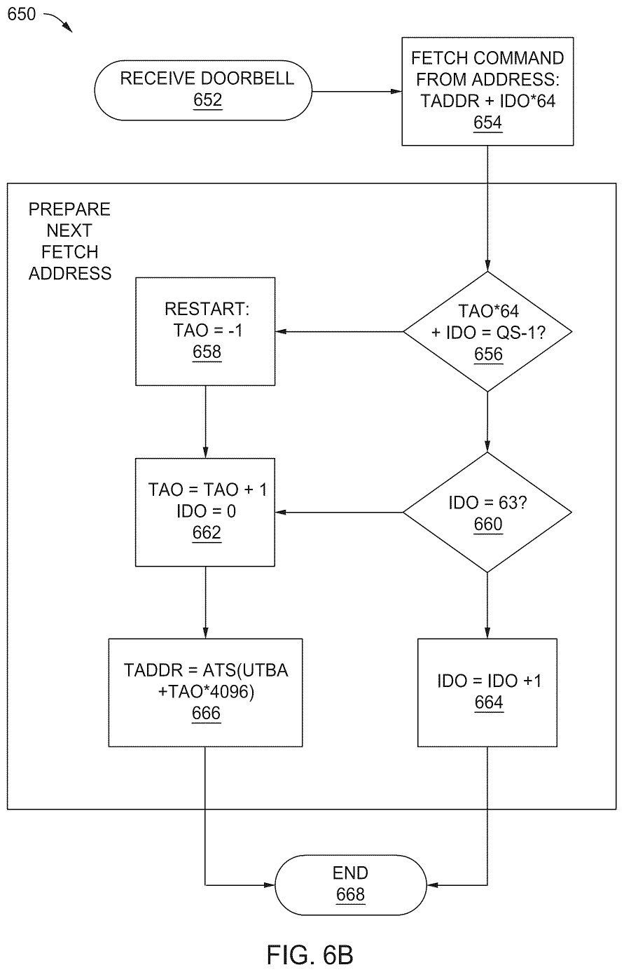

FIG. 6A is a flowchart 600 illustrating submission queue creation according to one embodiment. FIG. 6B is a flowchart 650 illustrating preparation of the next fetch address according to one embodiment. For receiving the create SQ command, when the data storage device receives a create SQ command at block 602, the data storage device stores the queue address (UTBA) and the queue size (QS) at block 604. The data storage device then translates the first address via ATS request to the host and store the results in translated address (TADDR) variable at block 606. The data storage device then initializes two variables to 0 at block 608. The first variable informs the 4K location (TAO), and the second variable informs the command location (IDO). As each 4K can contain 64 commands, TAO*64+IDO contains the index of the next command to fetch. The create SQ command is now completed at block 610.

For FIG. 6B, initially a doorbell is received at block 652. Thereafter, the command is fetched at block 654 from the correct address. The 4K translated address (i.e., TADDR) plus the offset inside the 4K (i.e., IDO*64). Then, the flow moves to calculate the next address to fetch. The preparation starts by checking if the last (previous) fetched command was the last command in the SQ, the data storage device controller does so by comparing the TAO*64+IDO to the queue size −1 at block 656. If the fetch was the last command, then the following steps are taken: TAO is restarted at −1 at block 658, TAO is set to 0 at block 662 and IDO is set to 0 at block 662, and TADDR gets retranslated based on UTBA at block 666. Breaking the flow into sub-steps: block 658 involves setting TAO=−1; block 662 involves TAO increased by 1 (and is now 0) and IDO is set to 0; block 666 involves TADDR is read based on base address of TAO (which 4K page index). If the fetch was not the last command at block 656, but is the last command in the 4K page at block 660, then increase TAO and set IDO to 0 at block 662, and translate the address for the next 4K portion at block 666. If the command is neither last in the SQ at block 656, nor last in the 4K portion at block 660, then the controller only increments the IDO at block 664 before ending the flow at block 668.

It is to be noted that the controller does re-request a translation once every time when re-starting at the head of the queue. However, the re-request is one translation per 64 commands, or one translation (i.e., 8 bytes) for 4K of command information which is ~0.003% of the bandwidth.

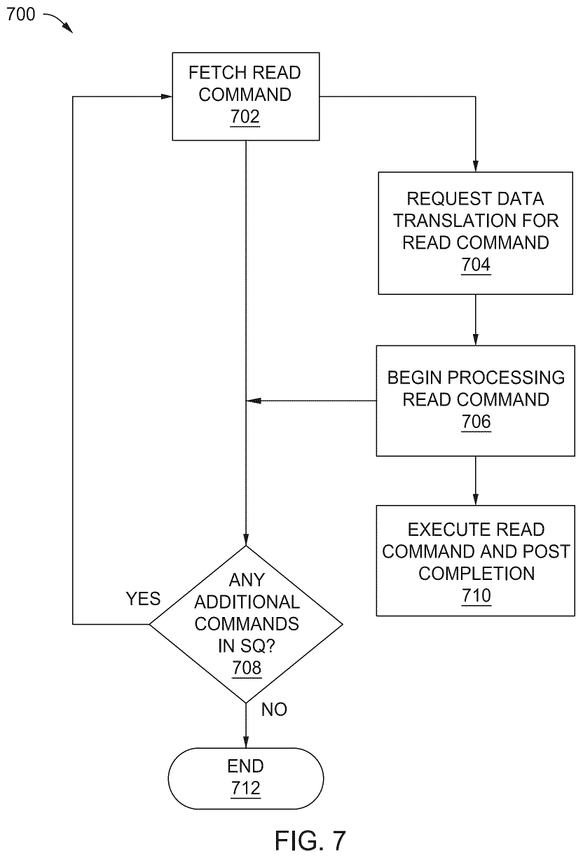

FIG. 7 is a flowchart 700 illustrating ATS processing according to one embodiment. Initially, a read command is fetched from a SQ at block 702. The data translation for the read command is then requested at block 704. Simultaneously, the SQ is checked at block 708 to determine whether there are any additional commands in the SQ. Following block 704, processing of the read command begins at block 706. Thereafter, the read command can be executed and a completion posted at block 710. Simultaneously with block 710, the determination is made at block 708. If no additional commands, then the process ends at block 712, but if there are additional commands in the SQ, then the process repeats back at block 702. Thus, if there are two commands in a SQ, the translation request for the second command occurs during processing of the first command. The translation request for the second command does not occur at the same time as the translation request for the first command. In other words, the translation request for the entire SQ does not occur all at once.

In another embodiment, when the translation granularity is bigger than 4K, less translation can occur. For example, for 8K STU, IDO will count to 128 (instead of 64), and the TAO will be multiplied by 8K instead of 4K.

In another embodiment, the data storage device can hold the translated address (in cache) of two entries. The two entries is of specific interest when the last entry is small (i.e., for 1 command) and a wrap should be done after fetching a single command. Having the next two addresses translated will resolve any bubbles that might be observed in the scenario.

By caching only the tail translated-address (aligned to 4K) of the SQ, the data storage device can save a lot of DRAM footprint at a very small cost to bandwidth.

In one embodiment, a data storage device comprises: a memory device; and a controller coupled to the memory device, wherein the controller is configured to: read a first command from a SQ using a translated address; prepare a next fetch address; execute the first command; and send a completion notification. The controller is configured to determine if the first command was at an end of a SQ. The controller is configured to set an untranslated address to a beginning of the SQ upon determining the first command was at the end of the SQ, and wherein the controller is configured to translate the untranslated address. The controller is configured to determine if the first command was in a last predetermined range of the SQ upon determining the first command was not at the end of the SQ. The controller is configured to set an untranslated address to a next predetermined range upon determining the first command was in the last predetermined range of the SQ, and wherein the controller is configured to translate the untranslated address. The controller is configured to increment a translated address by a command size upon determining the first command was not in the last predetermined range of the SQ. The controller is configured to reset a translated address offset and set an internal queue offset to 0. The controller is configured to increase the translated address offset. The controller is configured to set the translated address to be equal to a translated address provided by an address translation service (ATS) of untranslated base address plus the translated address offset times 4096 or bigger STU. The controller is configured to hold a translated address of two entries in cache.

It is to be noted that with regards to a first address translation and a second address translation, the first address translation may occur before even receiving a first command concerning the first address. Stated another way, the first address can be translated before receiving a first command from the first address so that the first translated address is ready at the time the first command is received. Similarly, the second address translation may occur before ever receiving a second command that involves the second address.

In another embodiment, a data storage device comprises: a memory device; and a controller coupled to the memory device, wherein the controller is configured to: receive a doorbell; perform an address translation on a SQ; fetch a first command from the SQ; execute the first command; and translate a SQ location for a second command, wherein the translating the SQ location for the second command occurs in parallel with executing the first command. The controller is configured to calculate a next address to fetch. The controller is configured to determine if the second command is a last command in the SQ. The determining is performed by comparing a size of the SQ to a calculation, wherein the calculation is the translated address offset multiplied by 64 and then added to the translated address offset. The controller is configured to store an untranslated base address of the SQ and a size of the SQ. The controller is configured to set translated address offset pointer to 0 and internal queue offset to 0. The controller is configured to hold a translated address of two entries of the SQ.

In another embodiment, a data storage device comprises: means to store data; and a controller coupled to the means to store data, wherein the controller is configured to: store a single untranslated base address per submission queue (SQ) in cache; and issue address translation requests on the fly, wherein the requests are issued before crossing address translation boundaries. The controller is configured to prepare a next fetch address after reading a different command from the means to store data using a translated address and before executing the different command and sending a completion. The controller is configured to adjust address translation service (ATS) granularity.

While the foregoing is directed to embodiments of the present disclosure, other and further embodiments of the disclosure may be devised without departing from the basic scope thereof, and the scope thereof is determined by the claims that follow.

1. A data storage device, comprising:
a memory device; and
a controller coupled to the memory device, wherein the controller is configured to:
read a first command from a submission queue (SQ) using a translated address;
prepare a next fetch address;
execute the first command; and
send a completion notification.

2. The data storage device of claim 1, wherein the controller is configured to determine if the first command was at an end of the SQ.

3. The data storage device of claim 2, wherein the controller is configured to set an untranslated address to a beginning of the SQ upon determining the first command was at the end of the SQ, and wherein the controller is configured to translate the untranslated address.

4. The data storage device of claim 2, wherein the controller is configured to determine if the first command was in a last predetermined range of the SQ upon determining the first command was not at the end of the SQ.

5. The data storage device of claim 4, wherein the controller is configured to set an untranslated address to a next predetermined range upon determining the first command was in the last predetermined range of the SQ, and wherein the controller is configured to translate the untranslated address.

6. The data storage device of claim 4, wherein the controller is configured to increment a translated address by a command size upon determining the first command was not in the last predetermined range of the SQ.

7. The data storage device of claim 1, wherein the controller is configured to reset a translated address offset and set an internal queue offset to 0.

8. The data storage device of claim 7, wherein the controller is configured to increase the translated address offset.

9. The data storage device of claim 1, wherein the controller is configured to set the translated address to be equal to a translated address provided by an address translation service (ATS) of untranslated base address plus the translated address offset times 4096 or bigger translation unit (STU).

10. The data storage device of claim 1, wherein the controller is configured to hold a translated address of two entries in cache.

11. A data storage device, comprising:
a memory device; and
a controller coupled to the memory device, wherein the controller is configured to:
receive a doorbell;
perform an address translation on a submission queue (SQ);
fetch a first command from the SQ;
execute the first command; and
translate a SQ location for a second command, wherein the translating the SQ location for the second command occurs in parallel with executing the first command.

12. The data storage device of claim 11, wherein the controller is configured to calculate a next address to fetch.

13. The data storage device of claim 12, wherein the controller is configured to determine if the second command is a last command in the SQ.

14. The data storage device of claim 13, wherein the determining is performed by comparing a size of the SQ to a calculation, wherein the calculation is the translated address offset multiplied by 64 and then added to the translated address offset.

15. The data storage device of claim 11, wherein the controller is configured to store an untranslated base address of the SQ and a size of the SQ.

16. The data storage device of claim 11, wherein the controller is configured to set translated address offset pointer to 0 and internal queue offset to 0.

17. The data storage device of claim 11, wherein the controller is configured to hold a translated address of two entries of the SQ.

18. A data storage device, comprising:
means to store data; and
a controller coupled to the means to store data, wherein the controller is configured to:
store a single untranslated base address per submission queue (SQ) in cache; and
issue address translation requests on the fly, wherein the requests are issued before crossing address translation boundaries.

19. The data storage device of claim 18, wherein the controller is configured to prepare a next fetch address after reading a different command from the means to store data using a translated address and before executing the different command and sending a completion.

20. The data storage device of claim 18, wherein the controller is configured to adjust address translation service (ATS) granularity.
